(19) United States
(12) Patent Application Publication
(10) Pub. No.: US 2004/0154224 A1
(43) Pub. Date: Aug. 12, 2004

(54) Steam processing

(76) Inventors: Frederick Michael Lewis, El Segundo, CA (US); Joshua Swithenbank, Hathersage (GB)

Correspondence Address: Kristin C Hiibner, Sheldon & Mak, 9th Floor, 225 South Lake Avenue, Pasadena, CA, 91101, US

(21) Appl. No.: 10/473,623

(22) PCT Filed: Mar. 28, 2002
(86) PCT No.: PCT/GB02/01221

(30) Foreign Application Priority Data
Mar. 29, 2001 (GB) 0107885.6

(51) Int. Cl. C01B 3/24; F23G 5/12; F02G 3/00; F02B 43/00

(52) U.S. Cl. 48/198.2; 110/229; 60/39.12

(57) ABSTRACT

Waste material is incinerated to heat water to produce low-temperature steam (12). The steam is mixed with oxygen (14) to produce synthetic air. Methane (22) (first fuel) is burnt in the synthetic air to produce ultra-superheated steam at about 1600° C. Coal particles (24) are gasified in the ultra-superheated steam producing a second fuel, which is combusted in hot air. The products of combustion are expanded isothermally in a turbine (T₁) to produce electricity (50). The hot waste gas from the turbine is used to heat air (52) isothermally compressed in a compressor (C₁) in the presence of a water spray (56). The heated air supports the combustion of the gasified coal and the cooled waste product is employed for district heating purposes.

This invention relates to steam processing, coal gasification, hydrogen production, and the efficient conversion of energy to useful forms.

It is known to incinerate domestic and industrial waste to create steam at not more than about 400° C. At this temperature, steam is not an efficient propellant to drive turbines, and only about 20% efficiency in energy conversion is achieved. A coal-fired power station uses steam at about 600° C. and achieves between 35-37% efficiency. Waste incineration cannot be permitted to reach higher temperatures because of the corrosive qualities of the typical chlorine content of waste.

It is an object of the present invention to make better use of waste-incineration-derived steam.

Ultra-superheated steam (USS) has recently been developed in a process which takes steam at relatively low temperatures (for example, about 400° C.) and mixes it with about 20% by weight of oxygen (to produce “synthetic air”). In this is burnt methane to produce a gas at about 1600° C. in which the steam partially dissociates into O⁻ and OH⁻ radicals and is very reactive.

In a first aspect, the present invention provides a method of gasification of solid carbonaceous material comprising the steps of injecting particles of said material into a stream of superheated steam at a temperature in excess of 600° C., preferably in excess of 1200° C., and preferably at about 1600° C.

The particle size is preferably less that 100 microns.

Preferably, said solid carbonaceous material is injected concentrically within said stream into a gasification chamber.

Preferably, the superheated steam is at about 1600° C. and, after gasification of the solid carbonaceous material, is at about 850° C. and 30 bar pressure. That is to say, the gasification reaction is endothermic. Indeed, it is a feature of the present invention that the heat of reaction is provided by the ultra-superheated steam, and not by combustion of the carbonaceous material. One effect of this is that the ash of the carbonaceous material (ie that which remains after gasification) is much cooler than it would otherwise be, had the material been combusted. As a consequence, the ash particles solidify instead of forming a liquid sludge that tends stick to the chamber walls. The process is therefore much cleaner.

Preferably, the solid carbonaceous material has a residence time of less than 2 seconds, and preferably about 1 second, before being gasified.

The product of said gasification is principally carbon monoxide and hydrogen. The solid carbonaceous material may be coal.

Preferably, said stream of superheated steam is ultra-superheated steam developed in a burner into which synthetic air and a combustible gas have been introduced and reacted.

Preferably, said synthetic air is produced by mixing oxygen with steam developed by the incineration of waste material.

It is well known that a combined cycle gas turbine is an efficient energy converter. A compressor pressurises a combuster in which natural gas is burnt producing gas output at 40 bar which drives a gas turbine (and the compressor) and generating electricity at about 35% efficiency. Waste gas at about 650° C. produces steam in a boiler which drives a steam turbine generating further electricity at about 25% efficiency, the waste steam being condensed in cooling towers before being recycled to the boiler. However the associated cooling towers and water treatment plant require a large area of land. As will become apparent, an aspect of the present invention calls for power and heat generation to be city based so that, among other things, a long distance transmission grid can be avoided, saving cost and efficiency.

It is a further object of the present invention to provide an energy converter that does not suffer from, or at least mitigates the effects of, at least some of the problems identified above.

Thus, in a second aspect of the present invention, there is provided an energy converter comprising a cooled steam turbine driven by ultra-superheated steam developed in a burner into which synthetic air and a combustible gas have been introduced and reacted. Said turbine may be cooled by cooling water circulated through internal passageways of the turbine.

Preferably, said combustible gas comprises gasified solid carbonaceous material according to the method of the first aspect of the present invention. A condenser may be employed to heat water with the waste gas from said cooled turbine to produce steam to drive a second stage turbine.

Preferably, said synthetic air is produced by mixing oxygen with steam developed by the incineration of waste material.

In accordance with a third aspect of the present invention, however, there is provided an energy converter comprising:

a compressor supplied with combustion-supporting gas at atmospheric temperature and pressure and a water spray to approximately isothermally compress the air to a first pressure;

a recuperator to heat the compressed combustion-supporting gas with hot waste gas;

a combuster to combust a combustible gas in said heated compressed combustion-supporting gas;

a gas turbine supplied with said combusted gas under pressure which undergoes approximate isothermal expansion to do work and produce said hot waste gas.

Said work may comprise driving an electricity generator and, optionally, said compressor.

Said first pressure is preferably between 5 and 10 bar. Said compressed combustion-supporting gas is preferably at about 200° C.

Said hot waste gas is preferably at a temperature of about 1100° C., said heated compressed combustion-supporting gas being at about 1000° C. and said waste gas being cooled in said recuperator to about 250° C.

Preferably, said combustible gas is gasified solid carbonaceous material according to the first aspect of the present invention. Said combustion-supporting gas may be air.

In a fourth aspect, the present invention provides an energy conversion process comprising:

a) incineration of combustible material to heat water to produce low-temperature steam;

b) mixing of the steam with oxygen to produce synthetic air;

c) burning a first fuel in said synthetic air to produce ultra-superheated steam;

d) gasifying solid carbonaceous particles in said ultra-superheated steam to produce a second fuel;

e) combusting said second fuel in hot combustion-supporting gas and expanding the resulting products of combustion substantially isothermally in a turbine doing work and producing hot waste gas;

f) substantially isothermally compressing combustion-supporting gas in the presence of a coolant; and

g) heating said combustion-supporting gas by recuperative heat exchange with said hot waste gas to produce said hot combustion-supporting gas employed in step e) above, and cool waste gas.

Preferably, said low-temperature steam is at about 400° C.

Preferably, said synthetic air is about 20% oxygen by weight.

Preferably, said first fuel is substantially methane, for example from natural gas. Said ultra-superheated steam is preferably at about 1600° C.

Preferably, said coal particles are less than 100 microns, perhaps about 70 microns, in maximum dimension.

Said particles are preferably injected into a stream of said ultra-superheated steam concentrically therein.

Preferably, said second fuel is at a temperature of about 850° C. and a pressure of about 30 bar.

Said hot combustion-supporting gas is preferably at about 1000° C., the products of combustion being at about 1500° C. In this way, few NOₓ products are produced.

Preferably, step e) is repeated using said hot waste gas as said hot combustion-supporting gas in a second stage expansion doing further work and producing second hot waste gas.

Preferably, said combustion-supporting gas is air and said coolant is water, ideally in a spray. Said compression is preferably to a pressure between 5 and 10 bar, perhaps about 8 bar. The temperature may be about 200° C.

Preferably, said recuperative heat exchange raises the temperature and pressure of the combustion-supporting gas to about 1000° C. and about 30 bar respectively.

Preferably, said cool waste gas is at about 250° C. and is used to heat water for district heating purposes.

The present invention has a number of benefits. Firstly, incineration of domestic and industrial waste is put to more efficient use than hitherto possible. Consequently, the more widespread introduction of waste incineration will be encouraged, reducing the demand for environmentally harmful landfill sites.

Secondly, coal, which is in plentiful supply for the foreseeable future, is the primary fuel for power generation, and yet in a process which produces little NOₓ.

Power generation (in the 50-100 MW range—sufficient for most cities' domestic requirements) can efficiently be effected in a power station incorporating the process of the present invention, and such a power station has a relatively small foot print not being burdened with the requirement for cooling towers and water treatment plant. Thus, the high costs of land area in a city environment can be offset by a low area requirement. Moreover, the benefits of avoiding connection to a wide-area grid by siting the power station close to the main electricity consumers can be experienced, as well as employing the waste heat for district heating.

In a fifth aspect, the present invention provides a method of production of hydrogen comprising:

a) incineration of waste material to heat water to produce low temperature steam;

b) mixing of the steam with oxygen to produce synthetic air;

c) burning a first fuel in said synthetic air to produce ultra-superheated steam;

d) gasifying carbonaceous material particles in said ultra-superheated steam to produce a mixture of gases;

e) cleaning said gases by injecting further steam; and

f) separating hydrogen from the resultant mixture.

Preferably said injection of further steam is of steam from step a) above.

The invention is further described hereinafter, by way of example, with reference to the accompanying drawings, in which:

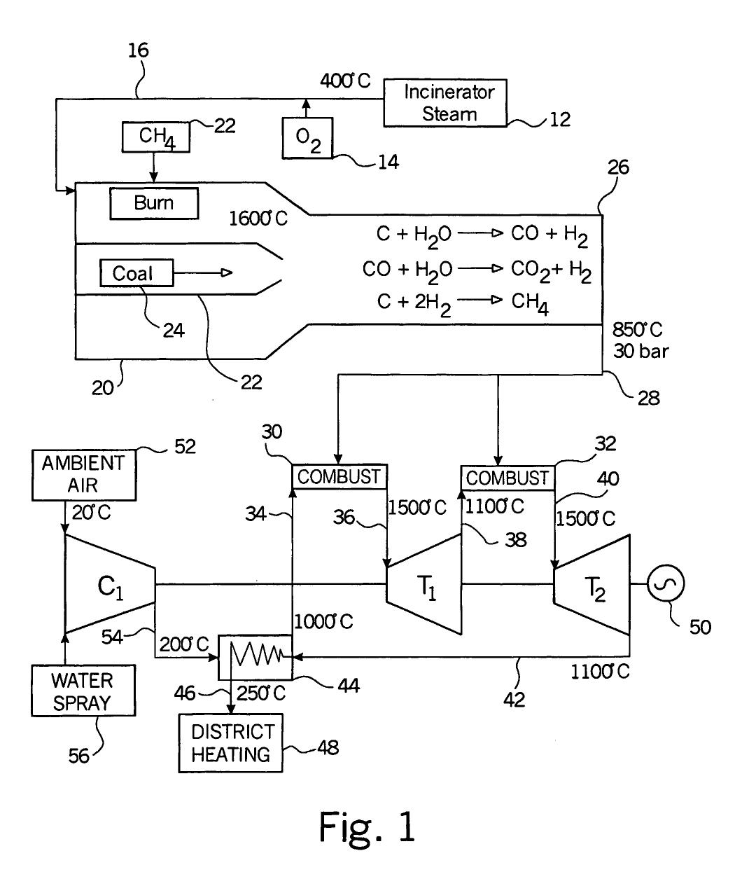

FIG. 1 is a schematic representation of the complete process according to the present invention in its first three aspects; and

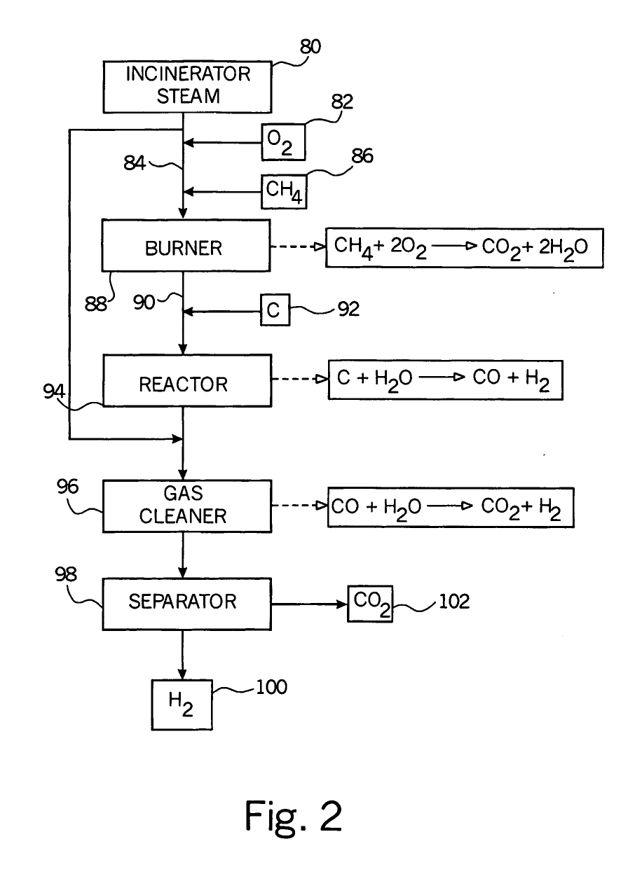

FIG. 2 is a process diagram of the fourth aspect of the present invention.

In FIG. 1, a waste incinerator 12 of known construction produces steam at 400° C. which is mixed with oxygen 14 to produce “synthetic air” in line 16. The synthetic air is passed to a burner 20 where a first fuel, natural gas 22, is burnt in the synthetic air to produce ultra-superheated steam at a temperature of about 1600° C. Concentrically disposed within the burner 20 is an injector 22 carrying a stream of coal particles 24 having a maximum size of about 70 microns. The coal particles are injected into the ultra-superheated steam where several endothermic reactions take place (as shown in the drawing), the end product of which is a second fuel comprising a mixture of hydrogen, carbon monoxide, carbon dioxide and methane at a temperature of about 850° C. The pressure of reactor chamber 26 will be about 30 bar. The residence time of the coal particles in the reactor chamber 26 before gasification is complete is about 1 second.

This second fuel constituted by the aforementioned mixture of gases, is passed along line 28 to first and second stage combusters 30, 32.

A hot combustion-supporting gas is fed into the first combuster 30 along line 34 and at a temperature of about 1000° C. (achieved in a process as described further below). The combustion products from the combuster 30 are at a temperature of about 1500° C. and are supplied to a first stage turbine T₁ along line 36. In turbine T₁, the combustion products are expanded to a temperature of about 1100° C. This hot, first stage, waste gas product is supplied to second combuster 32 along line 38. In second combuster 32, the second stage of combustion of the fuel mixture supplied along line 28 takes place and produces hot combustion products in line 40 at a temperature of about 1500° C. These products are supplied to second stage turbine T₂ where a second expansion of the products takes place and produces a second hot waste gas in line 42 at a temperature of about 1100° C. The purpose of re-heating the first stage waste gas product in the second combuster is to achieve a more nearly isothermal expansion to exploit to the thermodynamic efficiencies of this cycle. This is supplied to a recuperative heat exchanger 44, the output of which in line 46 is at a reduced temperature of about 250° C. The gases in line 46 are supplied to further heat exchangers (not shown) to heat water for the purpose of providing district heating 48.

The combustion in combusters 30, 32 is effected at relatively low pressure of about 8 and 4 bar respectively. For this reason, the conditions for the formation of NOₓ products is minimised and consequently the exhaust gas of the entire process is relatively free of these pollutants.

The turbines T₁, T₂ are employed to do work by driving electricity generator 50, as well as compressor C₁. Compressor C₁ is employed to substantially isothermally compress ambient air 52 at about 20° C. to a pressure of about 8 bar where it is supplied in line 54 to recuperative heat exchanger 44.

The compression in compressor C₁ is substantially isothermal by virtue of a spray of water 56 into the compressor C₁, which water spray absorbs heat on vaporisation. In the recuperative heat exchanger 44, the air steam mixture is heated to about 1000° C. where it is supplied to the first combuster 30 as the combustion-supporting gas in line 34.

A large measure of the heat of the process is recycled in the recuperative heat exchanger 44. Moreover, heat is not unnecessarily generated in the compression of the combustion-supporting gas. Finally, the waste gas is so cool (only about 250° C.) that it can be employed for district heating purposes in 48. For these reasons, the normal requirement for cooling towers and water-treatment plant that is found in conventional power generation stations is avoided. Consequently, the plant schematically represented in FIG. 1 can be housed on a relatively small industrial site close to a city centre. Consequently, the high cost of land in a city centre is offset by the reduced area required.

Turning to FIG. 2, this is a schematic representation of a process for the production of hydrogen gas where low-temperature steam, (for example, as generated in a waste incinerator), is provided at 80. Oxygen 82 is added to create synthetic air in line 84 which is then mixed with natural gas 86 and burnt in burner 88 to produce ultra-superheated steam in line 90. Coal particles 92 are added to the ultra-superheated steam in a reactor chamber 94, the product of which is hydrogen, carbon monoxide, carbon dioxide, and methane. More steam is injected in advance of a gas cleaner 96 which converts the carbon monoxide to carbon dioxide, and reduces water to hydrogen. Finally, a separator 98 separates the hydrogen 100 from the by-products 102 of the process, namely carbon dioxide and other gases.

For the avoidance of doubt, it is within the ambit of the present invention that ultra-superheated steam is made in a process in which a fuel is burnt in synthetic air, said air comprising a mixture of low-temperature steam and oxygen.

Preferably, said synthetic air comprises about 20% by weight oxygen. Said fuel is preferably methane. Said steam is preferably at a temperature of about 400° C., and is preferably developed through incineration of waste.

1. A method of gasification of solid carbonaceous material comprising the step of injecting particles of said carbonaceous material into a stream of superheated steam at a temperature in excess of 600° C.

2. A method as claimed in claim 1, in which the temperature of the superheated steam is in excess of 1200° C., preferably about 1600° C.

3. A method as claimed in claim 1 or 2, in which the particle size of the carbonaceous material is less than 100 microns, preferably about 70 microns.

4. A method as claimed in any preceding claim, in which said carbonaceous material is injected concentrically within said stream into a gasification chamber.

5. A method as claimed in any preceding claim, in which, after gasification of the carbonaceous material, the resultant gas mixture is at about 850° C. and about 30 bar of pressure.

6. A method as claimed in any preceding claim, in which the carbonaceous material has a residence time of less than 2 seconds before being gasified, and preferably about 1 second.

7. A method as claimed in any preceding claim, in which the product of said gasification is principally carbon monoxide and hydrogen.

8. A method as claimed in any preceding claim, in which said stream of superheated steam is ultra-superheated steam developed in a burner into which synthetic air and a combustible gas have been introduced and reacted.

9. A method as claimed in claim 8, in which said synthetic air is produced by mixing oxygen with steam developed by the incineration of waste material.

10. A method as claimed in claim 9, in which said synthetic air comprises about 20% by weight of said oxygen.

11. An energy converter comprising:
a) a compressor, supplied with air at atmospheric temperature and pressure, and a water spray, to compress the air, approximately isothermally, to a first pressure;
b) a recuperator to heat the compressed air with first hot waste gas;
c) a combuster to combust a combustible gas in said heated compressed air;
d) a gas turbine supplied with said combusted gas under pressure which undergoes approximate isothermal expansion to do work and produce said first hot waste gas.

12. A converter as claimed in claim 11, further comprising an electricity generator driven by said gas turbine

13. A converter as claimed in claim 11 or 12, in which said gas turbine drives said compressor.

14. A converter as claimed in any of claims 11 to 13, further comprising a second combuster also to combust said combustible gas, said first hot waste gas providing combustion-support for the combustible gas in the second combuster, a second gas turbine being supplied with the products of combustion in the second combuster, which products undergo approximate isothermal expansion to do further work and produce second hot waste gas.

15. A converter as claimed in any of claims 11 to 14, in which said first, and, in the case of claim 14, said second, hot waste gas is at a temperature of about 1100° C., said heated compressed air is at about 1000° C., and said hot waste gas is cooled in the recuperator to about 250° C.

16. A converter as claimed in any of claims 11 to 15, in which said first pressure is between 5 and 10 bar, preferably 8 bar.

17. A converter as claimed in any of claims 11 to 16, in which said compressed air is at about 200° C.

18. A converter as claimed in any of claims 11 to 17, in which said combustible gas is gasified carbonaceous material made by a method as claimed in any of claims 1 to 10.

19. An energy conversation process comprising:-
a) incineration of combustible material to heat water to produce low-temperature steam;
b) mixing of the steam with oxygen to produce synthetic air;
c) burning a first fuel in said synthetic air to produce ultra-superheated steam;
d) gasifying solid carbonaceous material particles in said ultra-superheated steam to produce a second fuel;
e) combusting said second fuel in hot combustion-supporting gas and expanding the resulting products of combustion substantially isothermally in a turbine doing work and producing first hot waste gas;
f) substantially isothermally compressing combustion-supporting gas in the presence of a coolant; and
g) heating said compressed combustion-supporting gas by recuperative heat exchange with said first hot waste gas to produce said hot combustion-supporting gas employed in step e) above, and to cool said waste gas.

20. A process as claimed in claim 19, in which said low-temperature steam is at about 400° C.

21. A process as claimed in claim 19 or 20, in which said synthetic air is about 20% oxygen by weight.

22. A process as claimed in claim 19, 20 or 21, in which said first fuel comprises methane, preferably obtained from natural gas.

23. A process as claimed in any of claims 19 to 22, in which said-ultra-superheated steam is at about 1600° C.

24. A process as claimed in any of claims 19 to 23, in which said carbonaceous material particles are less than 100 microns, preferably about 70 microns, in maximum dimension.

25. A process as claimed in any of claims 19 to 24, in which said particles are injected into a stream of said ultra-superheated steam concentrically therein.

26. A process as claimed in any of claims 19 to 25, in which said second fuel is at a temperature of about 850° C. and a pressure of about 30 bar.

27. A process as claimed in any of claims 19 to 26, in which said hot combustion-supporting gas is at about 1000° C., the products of combustion being at about 1500° C.

28. A process as claimed in any of claims 19 to 27, in which said combustion-supporting gas is air and said coolant is water, preferably in a spray.

29. A process as claimed in any of claims 19 to 28, in which said compression is to a pressure of between 5 and 10 bar, preferably about 8 bar.

30. A process as claimed in any of claims 19 to 29, in which said isothermally compressed combustion-supporting gas is at a temperature of about 200° C.

31. A process as claimed in any of claims 19 to 30, in which said recuperative heat exchange raises the temperature of the combustion-supporting gas to about 1000° C.

32. A process as claimed in any of claims 19 to 31, in which said cool waste gas is at about 250° C. and is used to heat water for district heating purposes.

33. A process as claimed in any of claims 19 to 32, in which step e) above is repeated using said first hot waste gas as said hot combustion-supporting gas in a second stage expansion doing further work and producing second hot waste gas.

34. A method of production of hydrogen comprising:-
a) incineration of carbonaceous material to heat water to produce low temperature steam;
b) mixing of the steam with oxygen to produce synthetic air;
c) burning a first fuel in said synthetic air to produce ultra-superheated steam;
d) gasifying carbonaceous material particles in said ultra-superheated steam to produce a mixture of gases;
e) cleaning said gases by injecting further steam; and
f) separating hydrogen from the resultant mixture.

35. A method as claimed in claim 34, in which the injection of steam into the gas cleaner employs steam from step a) above.

36. A method as claimed in any of claims 1 to 10, or a process as claimed in any of claims 19 to 33, in which said solid carbonaceous material is coal.

37. A process as claimed in any of claims 19 to 33, or in claim 36, in which said combustion-supporting gas is air.

38. A process as claimed in any of claims 19 to 33, or in claim 36 or 37 when dependent on any of claims 19 to 33, in which said combustible material is waste material.

39. A process for the production of ultra-superheated steam, in which a fuel is burnt in synthetic air, said air comprising a mixture of low-temperature steam and oxygen.

40. A process as claimed in claim 39, in which said synthetic air comprises about 20% by weight oxygen.

41. A process as claimed in claim 39 or 40, in which said fuel is methane.

42. A process as claimed in any of claims 39 to 41, in which said steam is at a temperature of about 400° C.

43. A process as claimed in any of claims 39 to 42, in which said steam and is developed through incineration of waste.
